(19) United States
(12) Patent Application Publication
(10) Pub. No.: US 2026/0135826 A1
(43) Pub. Date: May 14, 2026

(54) INTERFACE INTERACTION

(71) Applicant: Beijing Zitiao Network Technology Co., Ltd., Beijing (CN)

(72) Inventors: Jinyi Wang, Beijing (CN); Yue Chen, Beijing (CN)

(21) Appl. No.: 19/047,441

(22) Filed: Feb. 6, 2025

Related U.S. Application Data
(63) Continuation of application No. PCT/CN2024/131111, filed on Nov. 8, 2024.

(51) Int. Cl. H04L 51/02; G06F 3/04842; G06T 13/80

(52) U.S. Cl. CPC H04L 51/02; G06F 3/04842; G06T 13/80

(57) ABSTRACT

A method, an apparatus, a device and a storage medium for interface interaction are provided. In the method, in an interactive interface of a content, a first element associated with the content is presented, the first element indicates an interactive operation of a target user on the content. In response to receiving a first operation on the first element, an input panel and description information associated with the interactive operation are presented. Based on the input information received via the input panel, in a chat with the target user, sending of a message corresponding to input information is triggered.

### CROSS-REFERENCE

This application claims priority to International Patent Application No. PCT/CN2024/131111, filed on Nov. 8, 2024 and entitled ‘METHOD, APPARATUS, DEVICE, AND STORAGE MEDIUM FOR INTERFACE INTERACTION’, which is incorporated herein by reference in its entirety.

### FIELD

Example embodiments of the present disclosure generally relate to the computer field, and more particularly, to interface interaction.

### BACKGROUND

In recent years, with the development of the Internet, more and more users perform interactive activities in a net content platform, for example, publishing or browsing media content in a network platform, recommending or commenting on media content, and the like. However, the user cannot directly interact with other users recommending media content in a traditional network platform, leading to a lower interaction efficiency of the user.

### SUMMARY

In a first aspect of the present disclosure, a method for interface interaction is provided. In the method, in an interactive interface of a content, a first element associated with the content is presented. The first element indicates an interactive operation of a target user on the content. In response to receiving a first operation on the first element, an input panel and description information associated with the interactive operation are presented. Based on the input information received via the input panel, in a chat with the target user, sending of a message corresponding to input information is triggered.

In a second aspect of the present disclosure, an apparatus for interface interaction is provided. The apparatus includes a first presenting module, a second presenting module and a triggering module. The first presenting module is configured to present, in an interactive interface of a content, a first element associated with the content. The first element indicates an interactive operation of a target user on the content. The second presenting module is configured to in response to receiving a first operation on the first element, present an input panel and description information associated with the interactive operation. The triggering module is configured to trigger, in a chat with the target user, sending of a message corresponding to input information based on the input information received via the input panel.

In a third aspect of the present disclosure, an electronic device is provided. The device includes at least one processor; and at least one memory, coupled to the at least one processor and storing instructions executed by the at least one processor. The instructions, when executed by the at least one processor, cause the device to perform the method according to the first aspect of the present disclosure.

In a fourth aspect of the present disclosure, a computer readable storage medium is provided. The computer readable storage medium stores a computer program thereon. The computer program may be executed by a processor to implement the method according to the first aspect of the present disclosure.

It should be understood that what is described in this Summary is not intended to identify key features or essential features of the implementations of the present disclosure, nor is it intended to limit the scope of the present disclosure. Other features disclosed herein will become easily understandable through the following description.

### BRIEF DESCRIPTION OF THE DRAWINGS

The above and other features, advantages, and aspects of respective embodiments of the present disclosure will become more apparent from the following detailed description with reference to the accompanying drawings. The same or similar reference numerals represent the same or similar elements throughout the figures, where:

FIG. 1 illustrates a schematic diagram of an example environment in which some embodiments of the present disclosure may be implemented;

FIGS. 2A-2E illustrate example interfaces according to some embodiments of the present disclosure;

FIG. 3 shows a flowchart of an example process of interface interaction according to some embodiments of the present disclosure;

FIG. 4 illustrates a schematic structural block diagram of an example apparatus for interface interaction according to some embodiments of the present disclosure; and

FIG. 5 illustrates a block diagram of an electronic device capable of implementing various embodiments of the present disclosure.

### DETAILED DESCRIPTION

The embodiments of the present disclosure will be described in more detail with reference to the accompanying drawings, in which some embodiments of the present disclosure have been illustrated. However, it should be understood that the present disclosure may be implemented in various manners, and thus should not be construed to be limited to embodiments disclosed herein. On the contrary, those embodiments are provided for the thorough and complete understanding of the present disclosure. It should be understood that the drawings and embodiments of the present disclosure are only used for illustration, rather than limiting the protection scope of the present disclosure.

It should be noted that the headings of any sections/subsections provided herein are not limiting. Various embodiments are described throughout this specification, and any type of embodiment may be included under any section/subsection. Furthermore, embodiments described in any section/subsection may be combined in any manner with any other embodiments described in the same section/subsection and/or different sections/subsections.

As used herein, the term “including/comprising” and its variants are to be read as open terms that mean “including but not limited to.” The term “based on” is to be read as “based at least in part on.” The term “one embodiment” or “the embodiment” is to be read as “at least one embodiment.” The term “some embodiments” is to be read as “at least some embodiments.” Other definitions, explicit and implicit, might be further included below. The terms “first”, “second” and the like may refer to different or identical objects. Other explicit and implicit definitions may also be included below.

The embodiments of the present disclosure may involve user data, the acquisition and/or use of data, etc. These aspects shall comply with corresponding laws and regulations and relevant provisions. In the embodiments of this disclosure, all the collection, acquisition, treatment, processing, forwarding and use of data are performed with the user's knowledge and confirmation. Accordingly, when implementing respective embodiments of the present disclosure, the user should be informed of the type, scope of use, and use scenario of the data or information involved in the present disclosure in an appropriate manner in accordance with relevant laws and regulations, and user authorization should be obtained. The specific notification and/or authorization methods may vary according to the actual situation and application scenarios, and the scope of the present disclosure is not limited in this regard.

In the solutions in this specification and embodiments, the processing of personal information, if involved, will be processed on the premise of legal basis (such as obtaining the consent of the personal information subject, or necessary to perform the contract, etc.), and will only be processed within the specified or agreed scope. The user's refusal to process personal information other than the necessary information required for basic functions will not affect the user's use of basic functions.

As briefly mentioned above, with the development of the Internet, more and more users perform interactive activities in a network platform, for example, publishing or browsing media content in a network platform, interacting or commenting on media content, and the like. However, the user cannot directly interact with other users of the interactive media content in a traditional network platform, leading to a lower interactive efficiency of the user. Therefore, it is difficult to meet the user's interactive needs.

The embodiments of the present disclosure provide a solution for interface interaction. According to the solution, a first element associated with a content may be presented in an interactive interface of the content, the first element indicating an interactive operation of a target user on the content; in response to receiving a first operation on the first element, an input panel and description information associated with the interactive operation are presented; and a message corresponding to input information is triggered to be sent in a chat with the target user based on the input information received via the input panel.

In this way, the embodiments of the present disclosure may present, in an interactive interface of a content, an input panel and description information associated with an interactive operation based on a trigger for an element capable of indicating the interactive operation of a target user on the content. In addition, the present disclosure may receive input information based on the input panel, and send a message corresponding to the input information to the target user. Therefore, the embodiments of the present disclosure may conveniently provide the current user with an approach to message interaction with the target user of the interactive content, and further improve the interaction efficiency among users and meet the interaction requirement of users. Moreover, the present disclosure may provide the description information associated with the interaction for the current user, thereby improving the presentation efficiency of the information.

Various example implementations of the solution will be further described in detail below with reference to the accompanying drawings.

### Example Environment

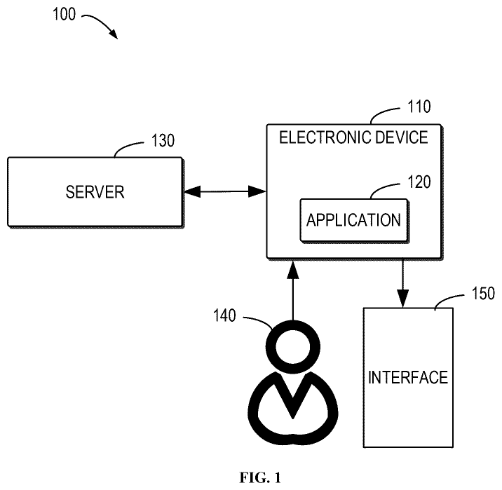

FIG. 1 shows a schematic diagram of an example environment 100 in which embodiments of the present disclosure may be implemented. As shown in FIG. 1, the example environment 100 may include an electronic device 110.

In this example environment 100, the electronic device 110 may run an application 120 that supports interface interaction. The application 120 may be any suitable type of application for interface interaction, examples of which may include but are not limited to: video applications, social networking applications, or other appropriate applications. A user 140 may interact with the application 120 via the electronic device 110 and/or a device attached thereto.

In the environment 100 of FIG. 1, if the application 120 is active, the electronic device 110 may present an interface 150 for supporting interface interaction through the application 120.

In some embodiments, the electronic device 110 communicates with a server 130 to enable the provision of services to the application 120. The electronic device 110 may be any type of mobile terminal, fixed terminal or portable terminal, including mobile phone, desktop computer, laptop computer, notebook computer, netbook computer, tablet computer, media computer, multimedia tablet, palmtop computer, portable game terminal, VR/AR device, personal communication system (PCS) device, personal navigation device, personal digital assistant (PDA), audio/video player, digital camera/camcorder, positioning device, TV receiver, radio broadcast receiver, e-book device, gaming device, or any combination of the foregoing, including accessories and peripherals for these devices or any combination thereof. In some embodiments, the electronic device 110 may also support any type of interface for the target user (such as “wearable” circuitry, etc.).

The server 130 may be an independent physical server, or a server cluster or distributed system composed of multiple physical servers, or may further be a cloud server providing basic cloud computing services such as cloud services, cloud databases, cloud computing, cloud functions, cloud storage, network services, cloud communications, middleware services, domain name services, security services, content distribution networks, and big data and artificial intelligence platforms. The server 130 may include, for example, a computing system/server such as a mainframe, an edge computing node, a computing device in a cloud environment, or the like. The server 130 may provide background services for the application 120 which supports interface interaction in the electronic device 110.

A communication connection may be established between the server 130 and the electronic device 110. Communication connections may be established in a wired or wireless manner. Communication connections may include but are not limited to Bluetooth connections, mobile network connections, universal serial bus (USB) connections, Wireless Fidelity (WiFi) connections, etc. The embodiments of the present disclosure are not limited in this regard. In the embodiments of the present disclosure, the server 130 and the electronic device 110 may implement signaling interaction through the communication connection between them.

It should be understood that the structure and function of various elements in the environment 100 are described for illustrative purposes only and do not imply any limitation on the scope of the present disclosure.

Some example embodiments of the present disclosure will be described below with reference to the accompanying drawings.

### Example Interaction

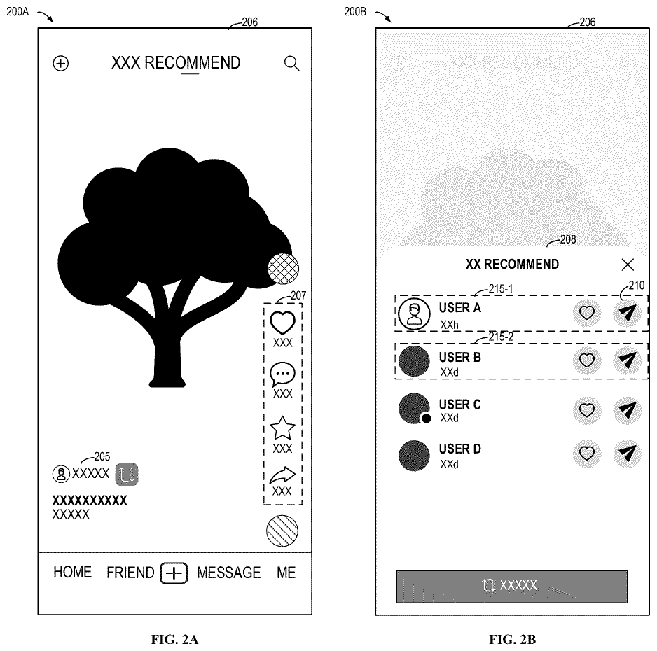

FIGS. 2A to 2E illustrate example interfaces 200A to 200E according to some embodiments of the present disclosure. The interfaces 200A to 200E may be provided, for example, by the electronic device 110 shown in FIG. 1.

In some embodiments, the electronic device 110 may present, in an interactive interface of a content, a first element associated with the content. The first element indicates an interactive operation of a target user on the content. As an example, the interactive operation may include a recommendation operation, a like operation, a comment operation or a favorite operation, and the like of the target user on the content. A recommendation operation will be taken as an example for description below.

In some embodiments, the interactive operation causes the content to be recommended to an associated user. As an example, the interactive operation (e.g., a recommended operation) of the target user on the content may be recommended to a user associated with the target user. As an example, a user associated with a target user may include other users following the target user, users following and followed by the target user, and/or users having a friend relationship with the target user, and so on.

In some embodiments, the interactive interface of the content may include a viewing interface of the content. As shown in FIG. 2A, the electronic device 110 may present a viewing interface 200A of a content 206. The electronic device 110 may present the content of the content 206 and associated information 207 (e.g., likes, comments, favorites, reposts, etc.) of the content 206 in the viewing interface 200A. As an example, the content 206 may include a media content work, such as a video content, a graphic content, and a musical content.

In some embodiments, the electronic device 110 may present a first element 205 indicating the interactive operation in the viewing interface 200A of the content 206 in response to interactive information of the content 206 satisfying a first condition. The first condition relates to the number of users of the recommended content 206. As an example, the first condition may indicate that the number of users of the recommended content 206 is one.

As an example, the electronic device 110 may present a user identifier of the target user in the first element 205. For example, the user identifier may include a profile identifier and/or a text identifier (for example, a user alias) of the target user. As an example, the electronic device 110 may also present, in the first element 205, at least part of a comment added by the target user on the interactive operation associated with the content 206. For example, the electronic device 110 may present the entire content of the comment in the first element 205. Alternatively, the electronic device 110 may present part of the content of the comment in the first element 205 (e.g., only the first 5 words of the comment) in response to the length of the comment (e.g., the number of text words) exceeding a preset threshold (e.g., “5 words”).

In some embodiments, the electronic device 110 may present, in the viewing interface 200A of the content 206, a second element indicating a group of interactive operations associated with the content 206 in response to the interactive information of the content 206 satisfying a second condition. As an example, the second condition may indicate at least two users performing an interactive operation on the content 206. As an example, the electronic device 110 may present, in the second element, identification information (e.g., a profile identifier and/or a name identifier) of at least one of a group of users of the interactive content 206.

As an example, the style in which the electronic device 110 presents the second element in the viewing interface 200A may include, for example, superimposing a plurality of profile identifiers corresponding to a plurality of users of the recommended content 206. In some examples, the electronic device 110 may display at most a preset number of profiles of users in the second element. When the number of users in the group is greater than a preset number, the second element may, for example, display a profile of a user with a higher degree of association with a current user. For example, the second element may display profiles of 3 users at most, and when 5 following users recommend the content 206, the second element may, for example, preferentially display profiles of users following each other.

In some embodiments, the electronic device 110 may indicate the number of users in the second element. As an example, the second element may indicate the number of users who once recommended the content 206 presented in the viewing interface 200A.

In other examples, the at least one user displayed by the electronic device 110 in the second element may also be determined according to the time when the group of users recommend the content 206. For example, the second element may display profiles of a predetermined number of users who have recently recommended the content 206.

In some embodiments, the group of users indicated by the second element may have a preset association relationship with the current user. As an example, the group of users may include other users followed by the user, or the group of users may include other users following and followed by the user. In some scenarios, the content 206 recommended by the user is only visible to the user's followers.

As an example, the electronic device 110 may receive a second operation on the second element. For example, the electronic device 110 may present an interactive panel associated with the content 206 in response to receiving a second operation (e.g., a click operation or a long-press operation, etc.) on the second element.

In some embodiments, as shown in FIG. 2B, the electronic device 110 may present the interactive panel 208 in an interactive interface 200B of the content 206. In some embodiments, the electronic device 110 may present, in the interactive panel 208, the first element indicating the interactive operation.

As an example, the electronic device 110 may present a group of elements corresponding to the group of users of the recommended content 206 in the interactive panel 208. As an example, the group of elements may include an element 215-1 associated with user A and an element 215-2 associated with user B. As an example, the first element may correspond to the element 215-1, for example.

As an example, the electronic device 110 may present a group of user identifiers, e.g., image identifiers and/or text identifiers, of the group of users of the recommended content 206 in a group of elements.

As an example, the image identifier may include a virtual figure set by the group of users in the application 120, for example, a profile picture, a digital person image, or the like. The text identification may include a username or alias of the group of users in the application 120.

In some embodiments, the electronic device 110 may also present time information of the group of users recommending the content 206 in the interactive panel 208. For example, the electronic device 110 may indicate that user A recommended the content 206 XX hours ago.

In some embodiments, the electronic device 110 and/or the server 130 may also determine whether the group of users has added a comment when recommending the content 206. For example, if user A adds a comment while recommending the content 206, the electronic device 110 may present, in the element 215-1, the comment added by user A when recommending the content 206.

In some embodiments, the ranking of elements corresponding to the group of users in the interactive panel 208 may be determined based on one or more of the following information: a time when the group of users recommends the content 206, a degree of association between the group of users and the current user, whether the group of users publishes a new content 206, whether the group of users newly recommends the content 206, whether the group of users has added comment content, and an online state of the group of users.

It should be understood that a display area of the interactive panel 208 displays at most elements corresponding to a preset number of users. When the number of users exceeds the preset number, the user may, for example, view more users by swiping the interactive panel 208.

In some embodiments, the electronic device 110 may further configure corresponding interactive logic for various identifiers or elements presented in the group of elements. In some embodiments, the user identifier (e.g., image identifier) of the group of users may be associated with the same interactive logic. For example, the electronic device 110 may present a personal page, a content page, or a private page of the user in response to a click on the user's profile photo.

In some embodiments, the electronic device 110 may receive a first operation on the first element. As an example, the first operation on the first element may be determined based on the interactive information of the content 206.

As an example, with continued reference to FIG. 2B, where the interactive information of the content 206 meets the foregoing second condition, the electronic device 110 may present a message portal 210 in the element 215-1. The first operation on the first element may include, for example, a click operation or a long-press operation on the message portal 210.

As an example, with continued reference to FIG. 2A, where the interactive information of the content 206 meets the foregoing first condition, the first operation on the first element may include, for example, a click operation or a long-press operation on the first element 205.

In some embodiments, as shown in FIG. 2C, the electronic device 110 may present, in response to receiving the first operation on the first element, an input panel 218 and description information associated with the interactive operation.

In some embodiments, the electronic device 110 may present the input panel 218 in a first area (for example, a lower half area in an interactive interface 200C), and present the description information in a second area (for example, an upper half area in the interactive interface 200C). Additionally, the electronic device 110 also presents at least part of the content of the content 206 in the second area. As an example, the electronic device 110 may superimpose the input panel 218 and the description information on the viewing interface of the content 206. For example, the electronic device 110 may superimpose a mask view on the viewing interface of the content 206 to reduce the transparency of the content 206 and highlight the input panel 218 and the description information.

As an example, the description information associated with the interactive operation may include identification information of the target user (for example, a profile photo identifier 214 and a name identifier of the target user, etc.).

As an example, the description information associated with the interactive operation may include time information of the interactive operation. For example, the electronic device 110 may present text 216 associated with ta time when the target user recommends the content 206 (e.g., “User A recommends this video XX hours ago”).

As an example, the description information associated with the interactive operation may include a comment added by the target user when recommending the content 206, for example, a comment 212 added by user A when recommending the content 206.

In some embodiments, the display style of the description information is determined based on the length of the comment content added by the target user when recommending the content 206. As an example, in order to have a better presentation effect, the electronic device 110 may determine a font size, a line display length, and the like of the comment content based on the length of the comment content (for example, the number of characters of the comment content). As an example, the electronic device 110 may display, in response to the length of the comment content not exceeding the preset threshold (for example, the number of characters being 5), the comment content based on a first font size (for example, size four) in the same line. As an example, the electronic device 110 may present the comment content based on a second font size (e.g., size five) in response to the length of the comment content exceeding the preset threshold. The electronic device 110 may display up to 5 characters in the same line, and display extra characters with a line break.

Additionally, the electronic device 110 may adjust a position of other content (e.g., the profile photo identifier 214 and/or the text 216) in the description information based on the length of the comment content.

In some embodiments, the electronic device 110 may trigger to send a message corresponding to input information in a chat with the target user based on the input information received via the input panel 218.

In some embodiments, the electronic device 110 may present a group of interactive controls in the input panel 218. As an example, the group of interactive controls may include one or more interactive controls. For example, the group of interactive controls may include an interactive control 220-1, an interactive control 220-2, and an interactive control 220-3.

In some embodiments, the group of interactive controls may correspond to preset interactive feedback, for example, like, applause, and the like. The user may, for example, generate feedback on the content 206 recommended by user A by triggering the interactive control, which may be sent to user A, for example, by way of a direct message or a message notification.

In some embodiments, the group of interactive controls may display a preset graphical element, and the graphical element may correspond to a preset interactive emoticon, for example. Taking FIG. 2C as an example, the interactive control 220-1 may display a heart element, and may correspond to an interactive emoticon “like”. Correspondingly, after the current user clicks the interactive control 220-1, the client corresponding to user A may push a notification or a direct message that the current user likes the recommended content 206.

In some embodiments, the type corresponding to the group of interactive controls may be a preset type. For example, all users may be associated with the same type of interactive control.

In still other embodiments, the type corresponding to the group of interactive controls may also be dynamically determined. In some scenarios, the type of interactive control may be determined based on first reference information associated with the content 206. As an example, the electronic device 110 may display an interactive control for generating festival blessing in response to the first reference information associated with the content 206, for example, indicating that the content 206 is media content associated with a festival (e.g., the Spring Festival), whose graphical element may be, for example, fireworks. As an example, the content 206 may be, for example, media content associated with a “dog,” and the group of interactive controls may include a graphical element associated with a “dog”.

Additionally or alternatively, the type of interactive control may be determined based on second reference information associated with the current user. The second reference information may be obtained with the knowledge and permission of the current user. As an example, the second reference information may indicate that the matching degree between the current user and the “applause” control is higher. Accordingly, the electronic device may display an interactive control for generating the applause feedback, and the graphical element may be, for example, palms.

Additionally or alternatively, the type of interactive control may be determined based on third reference information associated with the target user. The third reference information may be obtained with the knowledge and permission of the target user. As an example, the third reference information may indicate that the state set by the first user in the application 120 is in a party. Accordingly, the electronic device may display an interactive control for generating toast feedback, and the graphical element may be, for example, a wine glass.

In some embodiments, the display order of the group of interactive controls may be a preset order. For example, all users may be associated with a group of interactive controls in the same order.

In some embodiments, the display order of the group of interactive controls may be determined based on the first reference information, the second reference information, and/or the third reference information. For example, the electronic device 110 may preferentially present interactive controls associated with the content 206 from left to right.

In some embodiments, the electronic device 110 may obtain the input information based on a third operation on a target interactive control among the group of interactive controls. As an example, the electronic device 110 may obtain the input information corresponding to the target interactive control based on a click operation or a long-press operation on the target interactive control (for example, the interactive control 220-1) in the group of interactive controls. As an example, the input information corresponding to the interactive control 220-1 may include, e.g., a preset graphical element (e.g., a “heart” element) and/or a preset text content (e.g., “like the video you recommended”).

In some embodiments, as shown in FIG. 2D, the electronic device 110 may present, in an interactive interface 200D, an animation process associated with a graphical element in the target interactive control in response to receiving the third operation on the target interactive control. As an example, the electronic device 110 may present, in the interactive interface 200D, an animation process associated with a graphical element (e.g., a “heart” element) of the interactive control 220-1 in response to receiving a click operation on the interactive control 220-1. Illustratively, the animation process may include a movement process of a plurality of graphical elements (e.g., “heart” elements) from the input panel 218 to the profile photo identifier 214. As an example, the animation process may further include a process in which the plurality of graphic elements gets smaller and gradually disappear.

As an example, in the animation process, the interactive control 220-1 may be disabled, and the electronic device 110 will no longer respond to the user's trigger operation on the interactive control 220-1. Additionally, after the animation process ends, the electronic device 110 may re-display the graphical element in the interactive control 220-1, and may re-enable the interactive control 220-1. For example, the user may initiate new interactive feedback, for example, by clicking the interactive control 220-1.

In some embodiments, the electronic device 110 may, in response to receiving the third operation on the target interactive control, present in the interactive element an indication element 222 for indicating that a message corresponding to the input information has been sent (e.g., presenting the text “information sent” in the indication element 222).

In some embodiments, the electronic device 110 may also provide a keyboard control 224 in the input panel 218. Further, the electronic device 110 may obtain text information and/or voice information input by the current user via the keyboard control 224. The text information and/or the voice information is sent to the target user.

In some embodiments, with continued reference to FIG. 2C, the electronic device 110 may switch to the interactive interface where the content 206 is presented in response to receiving a fourth operation in the second area. The fourth operation is independent of the description information. As an example, the electronic device 110 may switch to the interactive interface where the content 206 is presented (e.g., the viewing interface of the content 206) in response to receiving a click operation in a blank area in the second area independent of the description information. That is, the electronic device 110 may stop presenting the input panel 218 and the description information in response to receiving the click operation in the blank area. In this way, the user may stop interacting with the target user in order to continue viewing the work content.

In some embodiments, as shown in FIG. 2E, the electronic device 110 may present a chat interface 200E with the target user (e.g., user A). The electronic device 110 may present, in the chat interface 200E, a message 225 corresponding to the input information and to be sent to the target user. As an example, the message 225 may indicate a reference to the content 206 recommended by the target user (e.g., a reference element 225-1). Additionally, the message 225 may include a predetermined reply content corresponding to the target interactive control. As an example, the predetermined reply content corresponding to the interactive control 220-1 may include a graphical element 225-2 (e.g., a “heart” element).

Based on the process described above, the embodiments of the present disclosure may, while a user views a content, present an interactive panel associated with a group of users of the recommended content for the user based on the user's selection of an interaction-related element, or present an input panel and description information associated with the target user of the recommended content. In addition, the present disclosure may further present a group of interactive controls in the input panel, to enable the current user to complete a quick reply to the recommended content.

In this way, the embodiments of the present disclosure may conveniently provide the user with an approach to viewing information associated with the recommended content and interacting with the user recommending the content, thereby increasing the efficiency of information obtaining of the user and improving the convenience of interaction between users. In addition, the embodiments of the present disclosure may further configure a group of interactive controls in the input panel based on a plurality of logics, increase the user's utilization efficiency of the input panel, and improve the efficiency of the user interacting with other users.

### Example Process

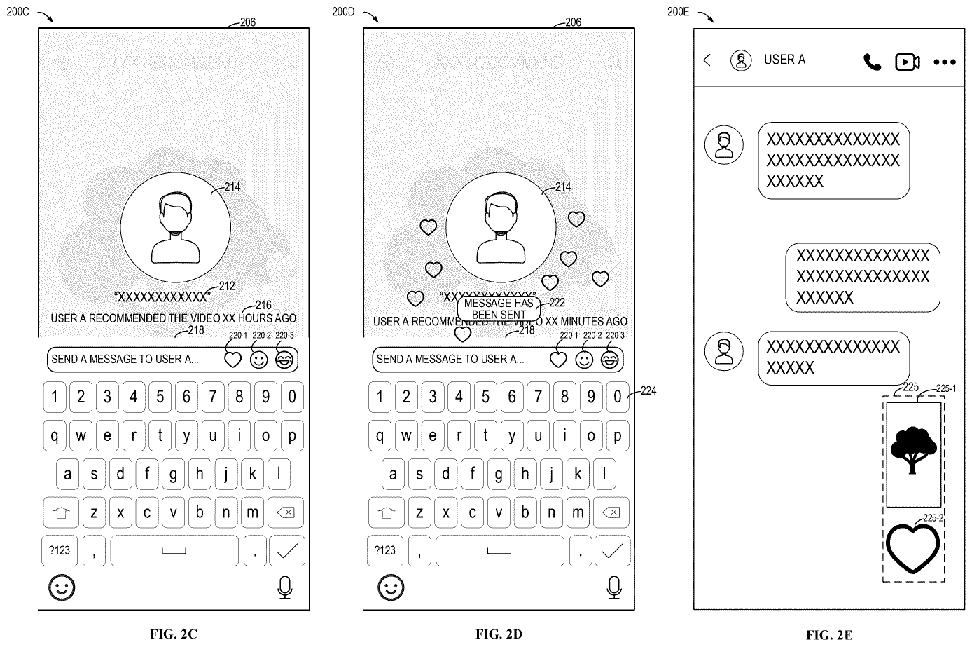

FIG. 3 illustrates a flowchart of an example process 300 of interface interaction according to some embodiments of the present disclosure. The process 300 may be implemented at the electronic device 110. The process 300 is described below with reference to FIG. 1.

As shown, at block 310, the electronic device 110 presents, in an interactive interface of a content, a first element associated with the content, the first element indicating an interactive operation of a target user on the content.

At block 320, the electronic device 110 presents an input panel and description information associated with the interactive operation in response to receiving a first operation on the first element.

At block 330, the electronic device 110 triggers the sending of a message corresponding to input information in a chat with the target user, based on the input information received via the input panel.

In some embodiments, the interactive interface includes a viewing interface of the content, and presenting the first element associated with the content includes: in response to interactive information of the content meeting a first condition, presenting the first element indicative of the interactive operation in the viewing interface of the content. The first condition is related to the number of users performing the interactive operation on the content.

In some embodiments, presenting the first element associated with the content includes: in response to receiving a second operation, presenting an interactive panel associated with the content; and presenting the first element indicative of the interactive operation in the interactive panel.

In some embodiments, the process 300 further includes: in response to interactive information of the content meeting a second condition, presenting, in the viewing interface of the content, a second element indicative of a group of interactive operations associated with the content; and receiving the second operation on the second element.

In some embodiments, the process 300 further includes: presenting a group of interactive controls in the input panel; and obtaining the input information based on a third operation on a target interactive control among the group of interactive controls.

In some embodiments, the process 300 further includes: in response to receiving the third operation on the target interactive control, presenting, in the interactive interface, an animation process associated with a graphical element in the target interactive control.

In some embodiments, a control type and/or display order of the group of interactive controls is determined based on at least one of: first reference information associated with the content; second reference information associated with a current user; or third reference information associated with the target user.

In some embodiments, the message indicates a reference to the content interacted with by the target user, and the message further includes a predetermined reply content corresponding to the target interactive control.

In some embodiments, the description information includes at least one of: comments added by the target user interacting with the content; identification information of the target user; or time information of the interactive operation.

In some embodiments, the display style of the description information is determined based on a length of a comment content added by the target user on the interactive operation associated with the content.

In some embodiments, presenting the input panel and the description information associated with the interactive operation includes: presenting the input panel in a first area and presenting the description information in a second area, the second area further presenting at least part of content of the content.

In some embodiments, the process 300 further includes: in response to receiving a fourth operation in the second area, switching to the interactive interface where the content is presented. The fourth operation is independent of the description information.

In some embodiments, the interactive operation causes the content to be recommended to an associated user.

### Example Apparatus and Device

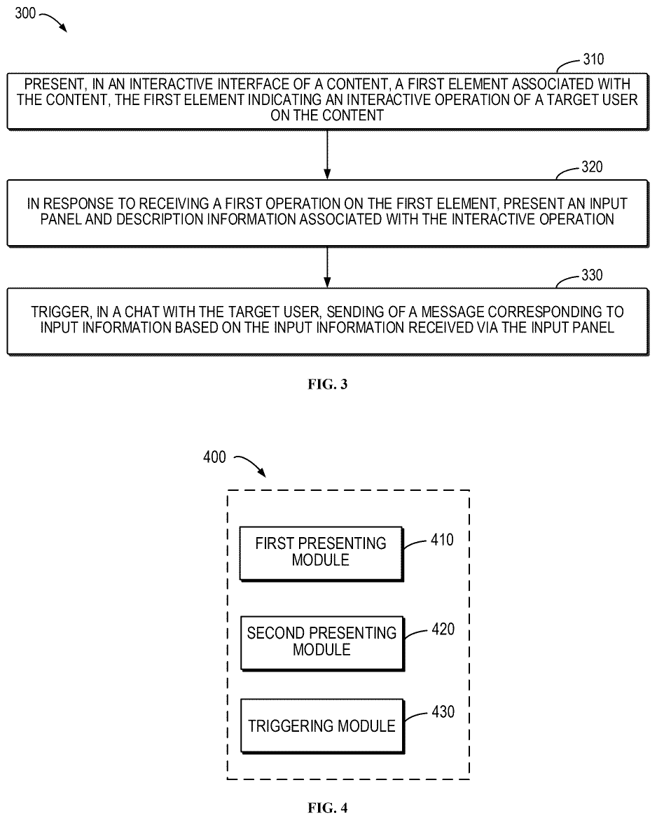

The embodiments of the present disclosure further provide a corresponding apparatus for implementing the above method or process. FIG. 4 illustrates a schematic structural block diagram of an example apparatus 400 for interface interaction according to certain embodiments of the present disclosure. The apparatus 400 may be implemented as or included in the electronic device 110. Respective modules/components in the apparatus 400 may be implemented by hardware, software, firmware, or any combination thereof.

As shown in FIG. 4, the apparatus 400 includes: a first presenting module 410 configured to present, in an interactive interface of a content, a first element associated with the content, the first element indicating an interactive operation of a target user on the content; a second presenting module 420 configured to present an input panel and description information associated with the interactive operation in response to receiving a first operation on the first element; and a triggering module 430 configured to trigger the sending of a message corresponding to input information in a chat with the target user, based on the input information received via the input panel.

In some embodiments, the interactive interface includes a viewing interface of the content, and the first presenting module 410 is further configured to: in response to interactive information of the content meeting a first condition, present the first element indicative of the interactive operation in the viewing interface of the content. The first condition is related to the number of users performing the interactive operation on the content.

In some embodiments, the first presenting module 410 is further configured to: in response to receiving a second operation, present an interactive panel associated with the content; and present the first element indicative of the interactive operation in the interactive panel.

In some embodiments, the apparatus 400 further includes a receiving module configured to: in response to interactive information of the content meeting a second condition, present, in the viewing interface of the content, a second element indicative of a group of interactive operations associated with the content; and receive the second operation on the second element.

In some embodiments, the apparatus 400 further includes an interacting module configured to: present a group of interactive controls in the input panel; and obtain the input information based on a third operation on a target interactive control among the group of interactive controls.

In some embodiments, the apparatus 400 further includes an animation module configured to: in response to receiving the third operation on the target interactive control, present, in the interactive interface, an animation process associated with a graphical element in the target interactive control.

In some embodiments, a control type and/or display order of the group of interactive controls is determined based on at least one of: first reference information associated with the content; second reference information associated with a current user; or third reference information associated with the target user.

In some embodiments, the message indicates a reference to the content recommended by the target user, and the message further includes a predetermined reply content corresponding to the target interactive control.

In some embodiments, the description information includes at least one of: comments added by the target user recommending the content; identification information of the target user; or time information of the interactive operation.

In some embodiments, the display style of the description information is determined based on a length of comment content added by the target user on the interactive operation associated with the content.

In some embodiments, the second presenting module 420 is further configured to: present the input panel in a first area and present the description information in a second area, the second area further presenting at least part of content of the content.

In some embodiments, the apparatus 400 further includes a switching module configured to: in response to receiving a fourth operation in the second area, switch to the interactive interface the content is presented. The fourth operation is independent of the description information.

In some embodiments, the interactive operation causes the content to be recommended to an associated user.

The units included in the apparatus 400 may be implemented in various ways, including software, hardware, firmware, or any combination thereof. In some embodiments, one or more units may be implemented using software and/or firmware, such as machine-executable instructions stored on a storage medium. In addition to or as an alternative to machine-executable instructions, some or all of the modules in the apparatus 400 may be implemented, at least in part, by one or more hardware logic components. By way of example, and not limitation, illustrative types of hardware logic components which may be used include field programmable gate arrays (FPGAs), application specific integrated circuits (ASICs), application specific standard products (ASSPs), systems on a chip (SOCs), complex programmable logic devices (CPLD), etc.

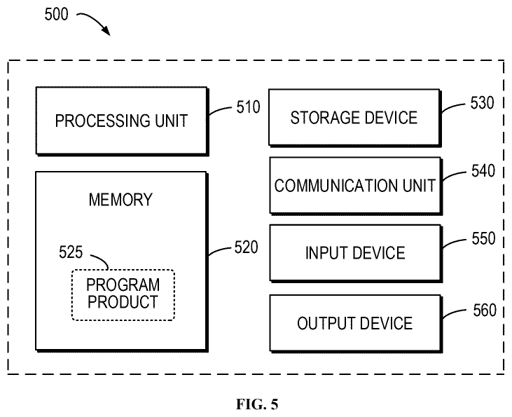

FIG. 5 shows a block diagram of an electronic device 500 that may implement one or more embodiments of the present disclosure. It should be understood that the electronic device 500 shown in FIG. 5 is merely illustrative and should not constitute any limitation on the functionality and scope of the embodiments described herein. The electronic device 500 shown in FIG. 5 may be used in an electronic device.

As shown in FIG. 5, the electronic device 500 is in the form of a general purpose computing device. Components of the electronic device 500 may include, but are not limited to, one or more processors or processors 510, a memory 520, a storage device 530, one or more communication units 540, one or more input devices 1550, and one or more output devices 560. The processor 510 may be a physical or virtual processor and may execute various processing based on the programs stored in the memory 520. In a multi-processor system, a plurality of processors executes computer-executable instructions in parallel to enhance parallel processing capability of the electronic device 500.

The electronic device 500 usually includes a plurality of computer storage mediums. Such mediums may be any attainable medium accessible by the electronic device 500, including but not limited to, a volatile and non-volatile medium, a removable and non-removable medium. The memory 520 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The storage device 530 may be a removable or non-removable medium, and may include a machine-readable medium (e.g., a memory, a flash drive, a magnetic disk) or any other medium, which may be used for storing information and/or data (e.g., training data for training) and be accessed within the electronic device 500.

The electronic device 500 may further include additional removable/non-removable, volatile/non-volatile storage mediums. Although not shown in FIG. 5, there may be provided a disk drive for reading from or writing into a removable and non-volatile disk (e.g., “floppy disk”) and an optical disc drive for reading from or writing into a removable and non-volatile optical disc. In such cases, each drive may be connected to a bus (not shown) via one or more data medium interfaces. The memory 520 may include a computer program product 525 having one or more program modules, and these program modules are configured for performing various methods or acts of various embodiments of the present disclosure.

The communication unit 540 implements communication with another computing device via a communication medium. Additionally, functions of components of the electronic device 500 may be realized by a single computing cluster or a plurality of computing machines, and these computing machines may communicate through communication connections. Therefore, the electronic device 500 may operate in a networked environment using a logic connection to one or more other servers, a Personal Computer (PC) or a further general network node.

The input device 550 may be one or more various input devices, such as a mouse, a keyboard, a trackball, a voice-input device, and the like. The output device 560 may be one or more output devices, e.g., a display, a loudspeaker, a printer, and so on. The electronic device 500 may also communicate through the communication unit 540 with one or more external devices (not shown) as required, where the external device, e.g., a storage device, a display device, and so on, communicates with one or more devices that enable users to interact with the electronic device 500, or with any device (such as a network card, a modem, and the like) that enable the electronic device 500 to communicate with one or more other computing devices. Such communication may be executed via an Input/Output (I/O) interface (not shown).

According to the example implementations of the present disclosure, a computer-readable storage medium is provided, on which computer-executable instructions are stored, the computer-executable instructions are executed by a processor to implement the method described above. According to the example implementations of the present disclosure, a computer program product is further provided, which is tangibly stored on a non-transient computer-readable medium and includes computer-executable instructions, which are executed by a processor to implement the method described above.

Aspects of the present disclosure are described herein with reference to flowchart illustrations and/or block diagrams of methods, apparatus (systems), and computer program products according to implementations of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that may direct a computer, a programmable data processing apparatus, and/or other devices to function in a particular manner, such that the computer readable storage medium having instructions stored therein includes an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods and computer program products according to various implementations of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

The descriptions of the various implementations of the present disclosure have been presented for purposes of illustration, but are not intended to be exhaustive or limited to implementations disclosed. Many modifications and variations will be apparent to those of ordinary skill in the art without departing from the scope and spirit of the described implementations. The terminology used herein was chosen to best explain the principles of implementations, the practical application or technical improvement over technologies found in the marketplace, or to enable others of ordinary skill in the art to understand implementations disclosed herein.

What is claimed is:

1. A method for interface interaction, comprising:
presenting, in an interactive interface of a content, a first element associated with the content, the first element indicating an interactive operation of a target user on the content;
in response to receiving a first operation on the first element, presenting an input panel and description information associated with the interactive operation; and
triggering, in a chat with the target user, sending of a message corresponding to input information based on the input information received via the input panel.

2. The method of claim 1, wherein the interactive interface comprises a viewing interface of the content, and presenting the first element associated with the content comprises:
in response to interactive information of the content meeting a first condition, presenting, in the viewing interface of the content, the first element indicative of the interactive operation, wherein the first condition is related to a number of users performing the interactive operation on the content.

3. The method of claim 1, wherein presenting the first element associated with the content comprises:
in response to receiving a second operation, presenting an interactive panel associated with the content; and
presenting, in the interactive panel, the first element indicative of the interactive operation.

4. The method of claim 3, further comprising:
in response to interactive information of the content meeting a second condition, presenting, in the viewing interface of the content, a second element indicative of a group of interactive operations associated with the content; and
receiving the second operation on the second element.

5. The method of claim 1, further comprising:
presenting a group of interactive controls in the input panel; and
obtaining the input information based on a third operation on a target interactive control among the group of interactive controls.

6. The method of claim 5, further comprising:
in response to receiving the third operation on the target interactive control, presenting, in the interactive interface, an animation process associated with a graphical element in the target interactive control.

7. The method of claim 5, wherein a control type and/or a display order of the group of interactive controls is determined based on at least one of:
first reference information associated with the content;
second reference information associated with a current user; or
third reference information associated with the target user.

8. The method of claim 5, wherein the message indicates a reference to the content interacted with by the target user, and the message further comprises a predetermined reply content corresponding to the target interactive control.

9. The method of claim 1, wherein the description information comprises at least one of:
a comment added by the target user interacting with the content;
identification information of the target user; or
time information of the interactive operation.

10. The method of claim 1, wherein a display style of the description information is determined based on a length of a comment content added by the target user on the interactive operation associated with the content.

11. The method of claim 1, wherein presenting the input panel and the description information associated with the interactive operation comprises:
presenting the input panel in a first area and presenting the description information in a second area, the second area further presenting at least part of content of the content.

12. The method of claim 11, further comprising:
in response to receiving a fourth operation in the second area, switching to the interactive interface where the content is presented, wherein the fourth operation is independent of the description information.

13. The method of claim 1, wherein the interactive operation causes the content to be recommended to an associated user.

14. An electronic device, comprising:
at least one processor; and
at least one memory coupled to the at least one processor and storing instructions executable by the at least one processor, the instructions, when executed by the at least one processor, causing the electronic device to perform acts comprising:
presenting, in an interactive interface of a content, a first element associated with the content, the first element indicating an interactive operation of a target user on the content;
in response to receiving a first operation on the first element, presenting an input panel and description information associated with the interactive operation; and
triggering, in a chat with the target user, sending of a message corresponding to input information based on the input information received via the input panel.

15. The electronic device of claim 14, wherein the interactive interface comprises a viewing interface of the content, and presenting the first element associated with the content comprises:
in response to interactive information of the content meeting a first condition, presenting, in the viewing interface of the content, the first element indicative of the interactive operation, wherein the first condition is related to a number of users performing the interactive operation on the content.

16. The electronic device of claim 14, wherein presenting the first element associated with the content comprises:
in response to receiving a second operation, presenting an interactive panel associated with the content; and
presenting, in the interactive panel, the first element indicative of the interactive operation.

17. The electronic device of claim 16, wherein the instructions, when executed by the at least one processor, causing the electronic device to perform acts further comprising:
in response to interactive information of the content meeting a second condition, presenting, in the viewing interface of the content, a second element indicative of a group of interactive operations associated with the content; and
receiving the second operation on the second element.

18. The electronic device of claim 14, wherein the instructions, when executed by the at least one processor, causing the electronic device to perform acts further comprising:
presenting a group of interactive controls in the input panel; and
obtaining the input information based on a third operation on a target interactive control among the group of interactive controls.

19. The electronic device of claim 18, wherein the instructions, when executed by the at least one processor, causing the electronic device to perform acts further comprising:
in response to receiving the third operation on the target interactive control, presenting, in the interactive interface, an animation process associated with a graphical element in the target interactive control.

20. A non-transitory computer readable storage medium having a computer program stored thereon, wherein the computer program is executable by a processor to implement acts comprising:
presenting, in an interactive interface of a content, a first element associated with the content, the first element indicating an interactive operation of a target user on the content;
in response to receiving a first operation on the first element, presenting an input panel and description information associated with the interactive operation; and
triggering, in a chat with the target user, sending of a message corresponding to input information based on the input information received via the input panel.
